(19) United States
(12) Patent Application Publication
(10) Pub. No.: US 2024/0093323 A1
(43) Pub. Date: Mar. 21, 2024

(54) STEEL COMPOSITION, WROUGHT ARTICLE AND MANUFACTURING METHOD OF A SEAMLESS PRESSURE VESSEL FOR COMPRESSED GAS

(71) Applicant: DALMINE S.P.A., BERGAMO (IT)

(72) Inventors: PAOLO BORTOT, BERGAMO (IT); MATTEO ORTOLANI, BERGAMO (IT); GIANLUCA BASSANINI, BERGAMO (IT); MICHELE SILEO, BERGAMO (IT); ERICK ARTURO ESCORZA MARQUEZ, BERGAMO (IT)

(73) Assignee: DALMINE S.P.A., BERGAMO (IT)

(21) Appl. No.: 18/254,942

(22) PCT Filed: Nov. 30, 2021
(86) PCT No.: PCT/EP2021/083606

§ 371 Date: May 30, 2023

(30) Foreign Application Priority Data
Nov. 30, 2020 (NL) 2027006

(51) Int. Cl. C21D 9/14; C21D 1/18; C21D 6/00; C21D 8/10; C22C 38/00; C22C 38/02; C22C 38/04; C22C 38/06; C22C 38/42; C22C 38/44; C22C 38/46; C22C 38/48; C22C 38/50; C22C 38/54; C22C 38/60

(52) U.S. Cl. CPC C21D 9/14; C21D 1/18; C21D 6/004; C21D 6/005; C21D 6/008; C21D 8/105; C22C 38/001; C22C 38/002; C22C 38/008; C22C 38/02; C22C 38/04; C22C 38/06; C22C 38/42; C22C 38/44; C22C 38/46; C22C 38/48; C22C 38/50; C22C 38/54; C22C 38/60; C21D 2211/008

(57) ABSTRACT

A steel composition includes, in wt. %:
C: 0.25-0.35;
Si: 0.20-0.35;
Mn: 0.40-0.60;
Cr: 1.20-1.70;
Ni: 1.40-1.90;
Mo: 0.15-0.25;
Al: 0.015-0.035;
Nb: 0.001-0.040;
V: 0.001-0.060;
N: 0.0030-0.0120;
Ca: 0.0010-0.0030; and
Fe.
   The wrought article made from this composition has a balanced set of mechanical properties including strength, ductility and toughness including resistance to fatigue crack propagation.

The present invention relates to a steel composition, a wrought article, a manufacturing method of a seamless pressure vessel, such as a large bottle or large cylinder for storage and transportation of a compressed gas, in particular hydrogen, as well as such a compressed gas cylinder and its use.

Pressure vessels for storage and transportation of compressed gas such as hydrogen need to be safe, reliable and affordable. Present pressure vessels contain a compressed gas, typically at a pressure in the range of 7-35 MPa. In view of economics it is desired to increase this pressure without jeopardizing safety and reliability.

High strength steel is the most common material choice for manufacturing the cylinder body of these pressure vessels. Hydrogen, however, generates embrittlement in ferritic steel, which impairs the ability of the steel to withstand loading-unloading cycles at high pressures. Hydrogen embrittlement acts by diffusion of atomic hydrogen through the steel lattice. As an interstitial element, hydrogen tends to segregate at lattice defects such as dislocations, grain boundaries, and at the interfaces with secondary phases such as non-metallic inclusions. At these latter interfaces, it is possible for atomic hydrogen to re-combine in molecular form, and generate an internal pressure, which adds up to external stresses and may be responsible for an early failure.

Hydrogen embrittlement can be counteracted by selecting higher alloy steels with superior overall performance. Higher alloyed steels suffer from increased costs. Also application of clean steelmaking practices and controlled manufacturing and heat treatment cycles offer a contribution to prevent hydrogen embrittlement.

Clean steelmaking practices have an important role in minimizing the sensitivity of the steel to embrittlement phenomena: by minimizing other elements contributing to steel embrittlement, such as metallic and non-metallic impurities, and most importantly by strictly controlling the amount and shape of non-metallic inclusions.

Additionally, manufacturing practices ensuring a fine-grained structure increase the toughness and fatigue resistance of the steel eventually making the steel suitable for hydrogen storage.

From the prior art various steel compositions intended for manufacturing hydrogen gas cylinders are known.

Steel compositions conforming to ASTM A372 grade N, classes 100 and 120 are commonly used for pressure vessels.

CN102191438A discloses a steel plate for high pressure seamless gas cylinders having a steel composition comprising, in wt. %, 0.28-0.40 C, 0.20-0.40 Si, 0.50-1.50 Mn, ≤0.010 S, ≤0.015 P, ≤1.20 Cr, ≤0.50 Mo, 0.10-0.50 Ni, 0.010-0.030 Ti and ≤0.050 Al, the balance being iron and inevitable impurities. The manufacturing process of the steel plate involves the steps of preparing the steel composition, casting the melted composition, hot rolling, coiling, heat preservation, and quenching and tempering, wherein each step is performed under certain process conditions. A steel plate thus manufactured has a yield strength higher than 990 MPa, a tensile strength exceeding 1100 MPa and an impact energy of more than 40 J/cm2 (−50° C.).

CN102409242A discloses an alloy steel for high strength gas cylinders having a steel composition comprising, in wt. %, 0.30-0.38 C, 0.15-0.37 Si, 0.60-0.90 Mn, 0.80-1.20 Cr, 0.15-0.30 Mo, 0.01-0.05 Al, 0.00-0.25 Ti, 0.02-0.25 Nb, 0.03-0.020 W, ≤0.010 S, ≤0.010 P and Ti+Nb≥0.07, 0.002-0.004 Ca, ≤0.0035 N, the balance being iron and inevitable impurities. The cylinder made from this composition has a tempered sorbite structure and its tensile strength is above 1100 MPa and the low temperature impact toughness at −50° C. is higher than 45 J/cm2.

US2019/0211414A1 discloses a steel pipe or tube for pressure vessels, comprising a chemical composition containing, in mass %, 0.10-0.60 C, 0.01-2.0 Si, 0.50-5.0 Mn, 0.005-3.0−Cr, 0.005-2.0 Mo, 0.01-0.06 Al, 0.0001-0.010 S, 0.0001-0.020 P, 0.0001-0.010 N, the balance being iron and inevitable impurities.

The present invention aims at providing a steel composition suitable for manufacturing wrought articles, in particular a seamless pressure vessel, such as a bottle or large cylinder for storage and/or transportation of compressed gas, particularly hydrogen, having a balanced set of properties regarding strength, ductility and toughness, in particular having an improved resistance to fatigue crack propagation in embrittling hydrogen conditions.

Another object is to provide a steel composition for a pressure vessel allowing to store a pressurized gas at higher pressure than typical maximum storage pressures today.

According to the invention in particular a steel composition for manufacturing a wrought steel article, in particular a seamless pressure vessel, such as a bottle or large cylinder for storage and/or transportation of compressed gas, particularly hydrogen, comprises, in wt. %:
C: 0.25-0.35;
Si: 0.20-0.35;
Mn: 0.40-0.60;
Cr: 1.20-1.70;
Ni: 1.40-1.90;
Mo: 0.15-0.25;
Al: 0.015-0.035;
Nb: 0.001-0.040;
V: 0.001-0.060;
N: 0.0030-0.0120;
Ca: 0.0010-0.0030;
Fe and inevitable impurities;
the optional elements, if any,
W: 0-0.20;
Ti: 0-0.025;
B: 0-0.0030;
the inevitable impurities, if present, comprising one or more of the elements
Cu: 0-0.30;
S: 0-0.01;
P: 0-0.015;
As: 0-0.020;
Sb: 0-0.005;
Sn: 0-0.025;
Pb: 0-0.01;
0: 0-0.003;
H: 0-0.00030.

Preferably the composition satisfies one or more of the following formulas:
4 C+Mn+0.6 Cr+0.5 Ni+Mo+0.5 W+166 B≥3.7 (also referred to as hardenabiliy parameter); and/or
[C+(Mn+Mo+W/2)/5+(Cr+Ni+V)/10]/[539−423 C−30.4 Mn−17.7 Ni−12.1 Cr−7.5 (Mo+0.5 W)−11 Si]×1000≤2.8 (also referred to as quench cracking parameter), and/or
270 C+70 (Mo+W/2)+450 V≥80 (also referred to as precipitation hardening parameter).

In the present invention a wrought article is understood in its broad sense as used in engineering, a product form that has been heated and worked, such as hot-formed, for example hot-rolled. A seamless pressure vessel for compressed gas storage and transportation is understood to be a packaging container, such as a large volume gas bottle or a gas cylinder with domed ends (and not a geometric cylinder).

It has been shown by the inventors that a steel composition according to the invention having the compositional elements in the indicated ranges and advantageously fulfilling the additional conditions of the three parameters allows to achieve a set of balanced properties regarding strength, ductility and toughness, resulting in a high resistance to fatigue fracture propagation compared to the prior art, which make the steel composition particularly suitable for manufacturing a pressure vessel for storing and transportation of hydrogen at pressures beyond the typical pressures encountered today.

An embodiment of the steel composition according to the invention comprises, in wt. %:
C: 0.25-0.35;
Si: 0.20-0.35;
Mn: 0.40-0.60;
Cr: 1.40-1.70;
Ni: 1.50-1.90;
Mo: 0.15-0.25;
Al: 0.015-0.035;
Nb: 0.001-0.040;
V: 0.001-0.060;
N: 0.0030-0.0120;
Ca: 0.0010-0.0030;
Fe and inevitable impurities;
the optional elements, if any,
W: 0-0.20;
Ti: 0-0.025;
B: 0-0.0030;
the inevitable impurities, if present, comprising one or more of the elements
Cu: 0-0.20;
S: 0-0.002;
P: 0-0.015;
As: 0-0.020;
Sb: 0-0.005;
Sn: 0-0.025;
Pb: 0-0.005;
O: 0-0.003;
H: 0-0.00030.

Another embodiment of the steel composition according to the invention comprises, in wt. %:
C: 0.25-0.35;
Si: 0.20-0.35;
Mn: 0.40-0.60;
Cr: 1.20-1.50;
Ni: 1.40-1.70;
Mo: 0.15-0.25;
Al: 0.015-0.035;
Nb: 0.001-0.040;
Ti: 0.010-0.025;
V: 0.001-0.060;
N: 0.0030-0.0120;
Ca: 0.0010-0.0030;
B: 0.0015-0.0030;
Fe and inevitable impurities;
the optional elements, if any
W: 0-0.20;
the inevitable impurities, if present, comprising one or more of the elements
Cu: 0-0.20;
S: 0-0.002;
P: 0-0.015;
As: 0-0.020;
Sb: 0-0.005;
Sn: 0-0.025;
Pb: 0-0.005;
O: 0-0.003;
H: 0-0.00030.

### Composition

Below an explanation of the steel composition according to the invention is presented. The amounts are indicated in wt. %.

Carbon (C) is required to strengthen the steel by means of precipitation of carbides in the last stage of heat treatment. An excessive amount of carbon produces a large increase in internal stresses upon quenching, which may result in cracking upon heat treating thick sections and reduction of toughness. Therefore the maximum carbon content is advantageously limited to 0.35% in order to avoid quench cracking. If the C content is too low, precipitation hardening and/or tempering resistance cannot be ensured Furthermore, for the intended application the steel composition does not need to be weldable. In view of these considerations, in the composition according to the invention the carbon content is in the range of 0.25-0.35, preferably 0.25-0.33, more preferably 0.27-0.33.

Manganese (Mn) is an important alloying element, with different functions. Upon cooling of austenite, it lowers the transformation temperature of austenite into ferrite: therefore, upon normalizing, it increases the rate of nucleation versus growth, and eventually results in refined grain size. Upon quenching instead, Mn increases the hardenability of the material, allowing to obtain a fully martensitic structure over larger sections. However, Mn reduces intergranular fracture strength (Grabke et al., 1987), and therefore excessive amounts affect impact toughness. Additionally, Mn promotes carbon segregation upon solidification, which is not desired. Advantageously Mn is limited to obtain a homogeneous structure of thick sections. Therefore Mn content in the steel composition is limited to the range of 0.40-0.60. Silicon (Si) is used for killing (deoxidizing) the steel. However, large amounts have an adverse effect on toughness. In addition, Si increases the sensitivity to temper embrittlement by enhancing segregation of P at grain boundaries (Smith, 1980; McMahon, 2001). The Si content is in the range of 0.20-0.35.

Nickel (Ni) is an austenite stabilizer, which allows refining the ferrite grain size thanks to lowering the transformation temperature in a manner akin to Mn. Ni increases the hardenability, and also improves toughness, having a limited impact on quench cracking. Excessive amounts, however, limit the maximum tempering temperature after quenching. Additionally, Ni is an expensive element. Therefore Ni is in the range of 1.40-1.90. Chromium (Cr) is effective in increasing the hardenability of the steel. As a carbide former Cr may permit the formation of bainite upon continuous cooling. However, increasing amounts of Cr diminish in effectiveness on hardening and increase the cost of steelmaking unnecessarily. The Cr content is in the range of 1.20-1.70.

Molybdenum (Mo) is very effective in increasing the hardenability of the steel, and being a strong carbide former allows the formation of bainite upon continuous cooling. Additionally, Mo enhances the resistance to tempering, allowing to maintain a desirable strength level while improving toughness and reducing internal stresses. High amounts however increase the cost of steelmaking unnecessarily. Therefore molybdenum is present in the range of 0.15-0.25.

Aluminium (Al) is a deoxidant and a nitride former. A minimum amount is required to ensure sufficient deoxidation, and it may be used to bind residual nitrogen. Excessive amounts may result in large non-metallic inclusions. Therefore aluminium is present in the range of 0.015-0.035.

Nitrogen (N) in one aspect, an inevitable residual element in steelmaking. Small amounts are in fact desirable because N can be exploited for controlling grain size by promoting the precipitation of nitrides with, for example, Al, Ti, Nb or V. However, free N (in interstitial solid solution) needs to be avoided because it promotes embrittlement and strain ageing phenomena. Therefore the N content is in the range of 0.0030-0.0120.

Vanadium (V) is a strong carbide and nitride former, and is used for increasing hardenability, achieving precipitation hardening, and refining the austenite grain size. Its effectiveness as the latter is limited by its solubility in austenite at higher temperatures. The V content is limited to the range of 0.001-0.060.

Also Niobium (Nb) and Titanium (Ti) are both strong carbide and nitride formers. Their role is similar to V in controlling austenite grain size, and are more effective than the former thanks to their low solubility in austenite. Titanium is more effective than Nb at higher temperatures (above about 1100° C.), whereas Nb generally results in a finer dispersion of precipitates and therefore allows achieving the finest prior austenitic grain size. Niobium is present in the range of 0.001-0.040. Titanium may be present as an optional element in the range of 0-0.025.

The steel composition according to the invention may contain other optional elements. Tungsten (W) may be present in the range of 0-0.20, more preferably 0-0.15. W has a similar role as Mo. However, about twice as much (in wt. %) is required to achieve a similar effect. Its practical application is effectively limited by costs.

Boron (B) may be present in the range of 0-0.0030. B can be used to improve hardenability; however, its effectivity diminishes when B is added in amounts above about 0.0030 wt. %.

Calcium (Ca) is present in the range of 0.0010-0.0030. Ca can be used to control the shape of non-metallic inclusions, promoting a round shape. A small residual amount of Ca is therefore tolerated. Such a residual amount is sometimes desirable as a demonstration that Ca treatment was effectively performed.

The steel composition according to the invention comprises inevitable impurities. Phosphorous (P), sulphur (S), tin (Sn), antimony (Sb), arsenic (As) and lead (Pb) are all considered inevitable impurities. They are known to negatively affect toughness of the steel. The range for phosphorous is 0-0.0150. Sulphur may be present in the range of 0-0.010, preferably 0-0.005, more preferably 0-0.002. Tin may be present in the range of 0-0.025, more preferably 0-0.020. Antimony may be present in the range of 0-0.005. Arsenic may be present in the range of 0-0.020, preferably 0-0.010. Lead may be present in the range of 0-0.010, preferably 0-0.005.

In the context of this invention copper (Cu) is also considered an inevitable impurity because of its inevitable presence in steel scrap. It slightly improves hardenability. However, large amounts of Cu may produce hot shortness. This decreases the surface quality (increases roughness) of hot finished products, and may also result in serious and unrepairable defectiveness. Cu is limited to the range of 0-0.30, preferably 0-0.20.

Oxygen (O) may be present in the range of 0-0.003, while hydrogen (H) may be present in the range of 0-0.00030, preferably 0-0.00018.

Iron (Fe) is the remaining component in the steel composition according to the invention.

### Parameters

In addition to the ranges of the individual elements in the steel composition according to the invention preferably one or more of the following equations apply:

In order to ensure sufficient hardenability and allow to achieve a microstructure comprising 90% or more martensite over a 76 mm (3 inch) section, advantageously the composition satifies the formula:

4 C+Mn+0.6 Cr+0.5 Ni+Mo+0.5 W+166 B≥3.7, preferably ≥4.1.

In order to prevent cracking upon quenching advantageously the composition satifies the formula, which reflects the susceptibility to quench cracking:

[C+(Mn+Mo+W/2)/5+(Cr+Ni+V)/10]/[539−423 C−30.4 Mn−17.7 Ni−12.1 Cr−7.5(Mo+0.5 W)−11 Si]×1000≤2.8, preferably ≤2.6).

In order to ensure sufficient strength after tempering advantageously the composition satisfies the formula:

270 C+70(Mo+W/2)+450 V≥80, preferably ≥100.

### Inclusions

Reducing the amount of non-metallic inclusions, and controlling the size and shape thereof improves toughness, fatigue resistance, and reduces sensitivity to hydrogen embrittlement. In order to achieve a low non-metallic inclusions content vacuum degassing is performed during preparation of the composition.

Advantageously the maximum content of metallic inclusions, if any, conforms to (ASTM E45)
A (sulphide)
   Thin: 0;
   Heavy: 0;
B (alumina)
   Thin: 1.5, preferably 1.0;
   Heavy: 1.0, preferably 0;
C (silicates)
   Thin: 1.5, preferably 1.0;
   Heavy: 1.0, preferably 0;
D (globular oxide)
   Thin: 2.0, preferably 1.5;
   Heavy: 1.0, preferably 0.5.
      Oversize inclusions can be present up to a maximum size of 50 μm, preferably less than 30 μm.

### Manufacturing Method

From the steel composition according to the invention a wrought article, in particular a seamless pressure vessel, more particularly a cylinder for storing and transportation of a compressed gas as explained above, can be manufactured.

According to the invention a manufacturing method of a seamless steel pressure vessel, in particular a large cylinder or bottle for storage and/or transportation of compressed gas, particularly hydrogen, comprises the steps of:
providing a hot-rolled seamless semi-finished object having a tubular body having a steel composition according to the invention as defined above;
an austenitization step of austenitizing the hot-rolled seamless semi-finished object having a tubular body between Ac3 and the grain coarsening temperature for a period of time sufficient to ensure full phase transformation;
a quenching step of quenching the object having a tubular body that has been subjected to austenitizing to a temperature below Mf at a cooling rate of at least 3° C./s between 800 and 500° C.;
a tempering step of tempering the quenched object having a tubular body at a temperature in the range of 600° C.—Ac1.

In a first step of the method according to the invention a hot-rolled seamless semi-finished object having a tubular body having a steel composition as defined above is provided. Typically the hot-rolled seamless semi-finished object is obtained through a process comprising:
HEATING A ROUND BILLET, PREFERABLY BY MEANS OF A ROTARY HEARTH FURNACE;
PIERCING THE BILLET, IN PARTICULAR ACCORDING TO THE MANNESMANN PROCESS;
HOT ROLLING E.G. ON A RETAINED MANDREL;
SIZING, ADVANTAGEOUSLY MANDREL-FREE SIZING;
OPTIONALLY, REHEATING AND EXPANDING;
COOLING TO ROOM TEMPERATURE, PREFERABLY IN STILL AIR;
CUTTING IN PARTICULAR TO A DESIRED LENGTH;
ENDS FORGING, ADVANTAGEOUSLY BY HOT SPINNING.

The semi-finished object or component thus obtained has a tubular body with forged ends. Typically the final size of the tubular body for a high pressure gas cylinder is between 350 mm and 700 mm in outer diameter, and the wall thickness is between 25 mm and 75 mm. In the forged ends, the wall thickness can increase up to 100 mm.

The hot-rolled seamless semi-finished object thus obtained is subjected to an austenitization step wherein it is heated to a temperature between Ac3 (representing the final critical temperature at which transformation to austenite is completed upon heating) and the grain coarsening temperature during a period of time to achieve full transformation to austenite, followed by quenching to a temperature below Mf (representing the martensite finishing temperature of the transformation into martensite), typically to ambient temperature. The cooling rate, typically calculated or measured as the average cooling rate through the whole wall thickness, in the quenching step is at least 3° C./second as determined between 800 and 500° C. The thus quenched object is tempered above 600° C. and below the Ac1 temperature (representing the starting temperature at which is transformed into austenite upon heating). The minimum tempering temperature of 600° C. is required to achieve excellent toughness by reducing internal stresses, while maintaining sufficient strength.

If V≤0.03, the preferred austenization temperature is 840-900° C. If V≥0.03 and/or Nb≥0.015, the preferred austenization temperature is 900-960° C.

As a guideline for the period of time to achieve full transformation, the austenitization step preferably comprises holding the hot-rolled seamless semi-finished object at a furnace temperature within ±10° C. from the targeted temperature in the range between Ac3 and the grain coarsening temperature for a period of time having a minimum time defined by wall thickness*1 min/mm wall thickness and a maximum time of 240 min. Grain coarsening is to be avoided.

Quenching may be performed by liquid spray or immersion in a liquid. Examples of suitable liquids include water, water-polymer solutions, oil and brine. The cooling rate is 3° C./s or more, preferably not less than 5° C./s, in the relevant temperature range from 800 down to 500° C. during quenching.

The tempering step is performed above 600° C. and below Ac1, preferably below 700° C., more preferably in the range between 600-670° C.

Advantageously the tempering step comprises holding the object for a period of time having a minimum value of at least wall thickness*3 min/mm wall thickness.

The prior austenitic grain size number (ASTM) is 7 or finer, i.e. the higher the number, the finer the grain size.

The balance of alloying elements in the composition according to the invention is such that, upon quenching from the austenitizing temperature at a cooling rate of 3° C./s between 800° C. and 500° C., the resulting microstructure is composed of at least 85% martensite.

### Microstructure

The microstructure of a wrought article, in particular a seamless pressure vessel, such as a bottle or large cylinder for storage and/or transportation of compressed gas, particularly hydrogen, having a steel composition according to the invention, comprises 85% or more martensite up to 100%, preferably 90% or more martensite, more preferably 95% or more martensite, the remainder being ferrite and bainite, preferably the remainder being bainite only.

The minimum amount of martensite may be demonstrated by means of hardness testing on a specimen cooled from the austenite range at known cooling rate. This corresponds to about the position at 38 mm (1.5 inch) from the cooled end on a standard Jominy specimen, tested according to ASTM A255. The minimum hardness is:

### Martensite Minimum Hardness (HRC)

85% 57×[% C]+26;
90% 58×[% C]+27;
95% 59×[% C]+29.

The almost fully martensitic microstructure allows to achieve a fine packet size, which in combination with high strength and low internal stresses offers a good fracture toughness and fatigue resistance.

### Mechanical Properties

A seamless pressure vessel, such as a bottle or large cylinder for storage and/or transportation of compressed gas, particularly hydrogen, according to the invention could be characterized by its properties regarding strength, ductility and toughness. Preferably the wrought article has at least one of the properties selected from the group consisting of:
Tensile strength (TS): ≥840 MPa;
Yield strength (YS): ≥660 MPa;
Hardness: ≥240 HV;
   and at least one of the properties selected from the group consisting of:
Total elongation: ≥15%;
Impact energy (V-notched sample): >100 J at −50° C. and >100 J at −40° C.;
Shear area: >50% ductile at −50° C., preferably >80% ductile at −50° C.;
   >80% ductile at −40° C., preferably >90% ductile at −40° C.
Toughness: In air, K_{IC}>250 MPa m^{0.5} from RT down to −40° C.,
   In hydrogen at 200-1000 bar, K_{IC}>50 MPa m^{0.5} at RT.

The first group is related to the strength characteristics, while the second group lists the properties regarding ductility and toughness.

Preferably the ratio YS/TS is 0.90.

For the preferred application of the wrought article as a gas cylinder in view of toughness in a hydrogen environment preferably the strength characteristics are:
Tensile strength (TS): 840-1250 MPa, more preferably 840-960 MPa,
Yield strength (YS): 660-1100 MPa, more preferably 660-760 MPa.
Hardness: 240-300 HV.

Advantageously the resistance to fatigue crack growth characteristic (ASTM E647) in hydrogen is
At 55 MPa H₂:
   da/dN<4·10⁻⁸ m/cycle at R=0.1 and ΔK≤10 MPa*m^{1/2};
   da/dN<2·10⁻⁸ m/cycle at R=0.7 and ΔK≤7 MPa*m^{1/2};
At 106 MPa H₂:
   da/dN<6·10⁻⁸ m/cycle at R=0.1 and ΔK≤10 MPa*m^{1/2};
   da/dN<5·10⁻⁸ m/cycle at R=0.7 and ΔK≤7 MPa*m^{1/2}.

Most preferably the wrought article has all of the above properties and characteristics. The invention also relates to a high pressure hydrogen gas storage cylinder comprising a seamless pressure vessel as defined above. The thick wall cylinder according to the invention having the balanced set of properties due to its composition and microstructure as outlined above is particularly suitable for storing a high compressed gas, in particular hydrogen.

In a further aspect the invention relates to the use of such a seamless pressure vessel for storing compressed gas, such as hydrogen, at a pressure up to 120 MPa (1200 bar), in particular in the range of 50-100 MPa.

### EXAMPLES

Steel compositions A through E according to the invention as indicated in below Table 1 were prepared including vacuum degassing. Table 1 also lists comparative compositions F through Z2 originating from various prior art documents, which documents are identified in Table 2.

The compositions A-E were made into a hollow cylindrical body, which was subjected to a heat treatment as shown in Table 3. The final dimensions of the cylindrical bodies thus manufactured are presented in Table 4. Data on non-metallic inclusions and grain size are contained in Tables 5 and 6 respectively. Table 7 gives the parameters relating to hardenability, quench cracking and precipitation hardening as defined above.

The mechanical properties are presented in Tables 8-12.

Where available, the relevant data from the prior art references relating to comparative examples F through Z2 are incorporated in these Tables.

It is well known that hydrogen embrittlement strongly depends on strain rate conditions during tests executions. For this reason, as an example, tensile tests are typically conducted with nominal strain rate of 10-5 s-1, in order to allow hydrogen to diffuse into the bulk of the material and actually promote the embrittlement (reference standard CSA—Test Methods for evaluating material compatibility in compressed hydrogen applications—Metals, 2014). Performing tests, such as impact energy on V-notch specimens, even on hydrogen-charged samples, is not representative of the actual material behaviour under real service conditions. The rapid strain rate occurring during the fast fracture associated with an impact test may actually preclude the occurrence of hydrogen embrittlement, therefore not providing quantitative information on the actual material performance. Therefore the toughness of the material is measured as the threshold stress intensity factor for hydrogen assisted cracking occurrence (KIH).

ASME BPVC Section VIII Div.3, art. KD-10 requires fatigue crack propagation and fracture toughness to be measured on the material under hydrogen conditions expected to be seen during service life.

Fatigue crack growth rate testing was conducted following procedures of ASTM E647 using the compact tension (CT) geometry. The nominal geometry of the CT specimens was: thickness (B)=12.7 mm; width (VV)=26 mm; and starter notch length=5.2 mm. The standard designation for the orientation of the specimens is CL: loading in the circumferential direction with the crack propagating in the longitudinal direction. Fatigue precracking was conducted in air at a frequency of 10 to 15 Hz at a load ratio (R: equal to the minimum applied load divided by the maximum load) of 0.1.

Fatigue crack growth tests were conducted in gaseous hydrogen at a pressure of up to 106 MPa, following procedures consistent with the methods outlined in CSA CHMC1 for tests in high-pressure gaseous hydrogen and also consistent with the ASME Boiler and Pressure Vessel Code, Section VIII, Division 3, Article KD-10, except that higher frequencies were used in this study: up to 1 Hz compared to the specified frequency of 0.1 Hz.

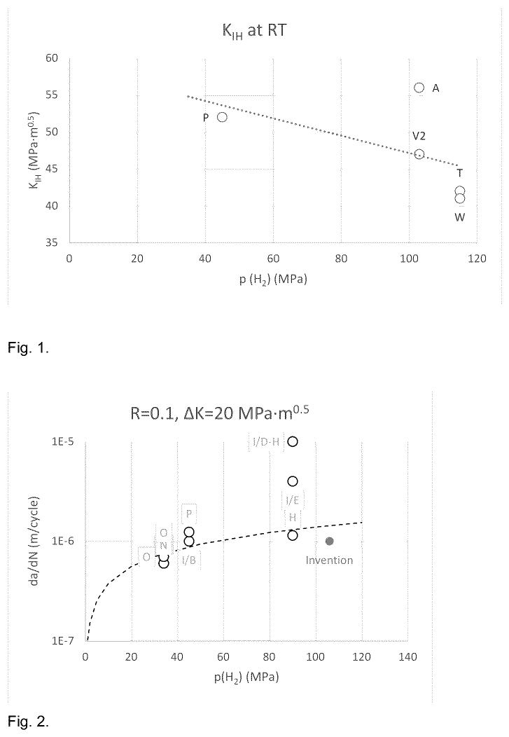

FIG. 1 is a graph illustrating the toughness data from Table 9.

As is clear from Table 9 and FIG. 1 the steel composition according to the invention allows to manufacture pressure vessels suitable for storage and transport of compressed hydrogen gas having a toughness under hydrogen pressure exceeding the prior art.

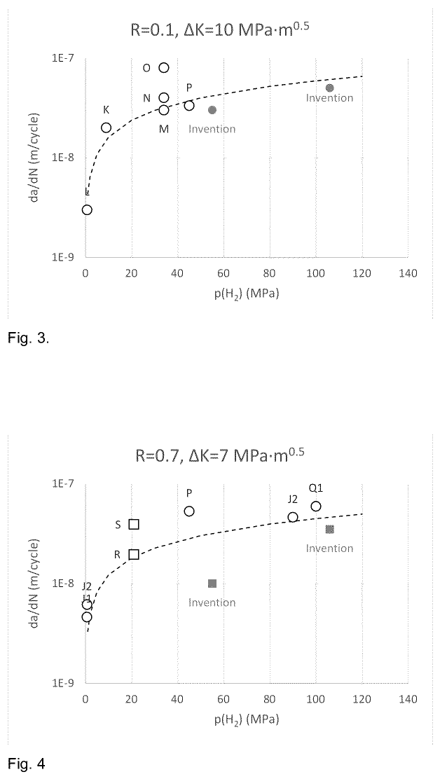

FIGS. 2-4 are graphs illustrating the fatigue behaviour of the product of the invention and where available from the prior art references under the various examined conditions. It is evident that the example of the invention shows excellent resistance to fatigue crack propagation, even in embrittling hydrogen environment.

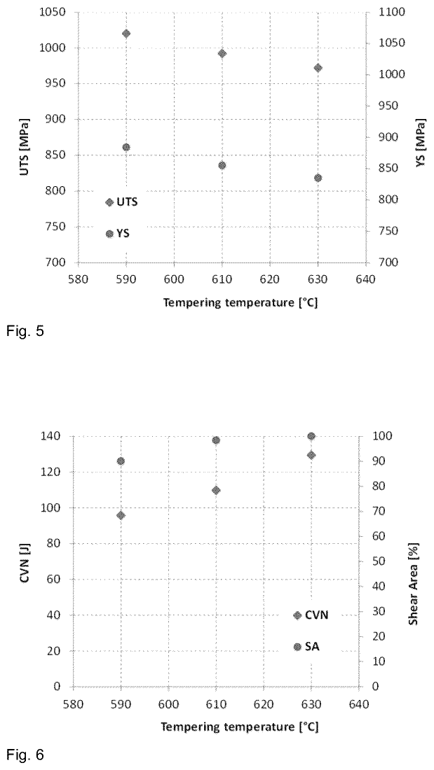

FIG. 5 illustrates the tensile strength (♦) and yield strength (●) (at room temperature) as a function of the tempering temperature for steel composition A.

FIG. 6 shows the impact energy and shear area (♦) (●) (at −60° C.) as a function of the tempering temperature for steel composition A.

As is apparent the invention allows to achieve strength and toughness by tempering at a temperature above 600° C.

TABLE 1
Compositions

| Ex | ID | Grade | C | Mn | Si | P | S | Ni | Cr | Mo | Cu | V |
|---|---|---|---|---|---|---|---|---|---|---|---|---|
| INV | A | 1.5NiCrMo | 0.33 | 0.57 | 0.25 | 0.009 | 0.002 | 1.55 | 1.48 | 0.22 | 0.15 | 0.006 |
| INV | B | 1.5NiCrMo | 0.33 | 0.53 | 0.28 | 0.013 | 0.001 | 1.55 | 1.48 | 0.22 | 0.14 | 0.007 |
| INV | C | 1.5NiCrMo | 0.33 | 0.59 | 0.25 | 0.01 | 0.002 | 1.58 | 1.47 | 0.22 | 0.14 | 0.006 |
| INV | D | 1.5NiCrMo | 0.33 | 0.53 | 0.28 | 0.011 | 0.001 | 1.56 | 1.5 | 0.23 | 0.11 | 0.006 |
| INV | E | 1.5NiCrMo | 0.32 | 0.53 | 0.27 | 0.011 | 0.001 | 1.61 | 1.48 | 0.21 | 0.14 | 0.006 |
| COMP | F | 2NiCrMoV | 0.18 | 0.55 | 0.22 | 0.016 | 0.016 | 2.05 | 1.09 | 0.49 | | 0.11 |
| COMP | G | 3NiCrMoV | 0.19 | 0.30 | 0.29 | 0.007 | 0.008 | 3.50 | 1.55 | 0.44 | | 0.12 |
| COMP | H | SCM435 | 0.36 | 0.79 | 0.28 | 0.021 | 0.011 | 0.06 | 0.99 | 0.17 | | |
| COMP | I | SCM439 | 0.42 | 0.80 | 0.22 | 0.014 | 0.0023 | 1.82 | 0.86 | 0.25 | | |
| COMP | J | SCM439 | 0.43 | 0.82 | 0.28 | 0.004 | 0.002 | 1.95 | 0.9 | 0.23 | | |
| COMP | K | SCM440 | 0.38 | 0.64 | 0.18 | 0.014 | 0.002 | 0.07 | 1.04 | 0.15 | 0.12 | 0.01 |
| COMP | L | SCM435 | 0.37 | 0.84 | 0.22 | 0.012 | 0.005 | 0.03 | 1.15 | 0.24 | | |
| COMP | M | X52 vintage | 0.24 | 0.96 | 0.06 | 0.011 | 0.021 | 0.05 | 0.01 | | 0.01 | 0.002 |
| COMP | N | X52 modern | 0.07 | 1.06 | 0.24 | 0.012 | 0.004 | 0.02 | 0.01 | | 0.02 | 0.004 |
| COMP | O | X70 | 0.05 | 1.43 | 0.17 | 0.009 | 0.001 | 0.14 | 0.24 | 0.01 | 0.22 | 0.004 |
| COMP | P | 4130X | 0.29 | 0.62 | 0.28 | 0.008 | 0.004 | | 0.92 | 0.19 | | |
| COMP | Q | SA-372 J | 0.35- | 0.75- | | ≤0.025 | ≤0.025 | | 0.80- | 0.15- | | |
| | | | 0.50 | 1.05 | | | | | 1.15 | 0.25 | | |
| COMP | R | X100 | 0.09 | 1.69 | 0.26 | | | | 0.19 | 0.17 | | |
| COMP | S | SA-372 J | 0.49 | 0.93 | 0.28 | | | | 0.99 | 0.18 | | |
| COMP | T | SCM439 | 0.4 | 0.79 | 0.25 | 0.004 | 0.005 | 1.89 | 0.82 | 0.24 | | |
| COMP | V1 | 4130X | 0.29 | 0.62 | 0.28 | 0.008 | 0.004 | | 0.92 | 0.19 | | |
| COMP | V2 | SA-372 J | 0.49 | 0.93 | 0.28 | 0.008 | 0.004 | | 0.99 | 0.18 | | |
| COMP | V3 | DOT-3T | 0.45 | 0.86 | 0.25 | 0.013 | 0.006 | | 0.97 | 0.18 | | |
| COMP | W1 | SCM435 | — | | | | | | | | | |
| COMP | W2 | SCM435 | — | | | | | | | | | |
| COMP | Z1 | AISI 4130 | 0.36 | 0.71 | 0.29 | 0.012 | 0.001 | 0.13 | 1.07 | 0.21 | 0.17 | 0.01 |
| COMP | Z2 | AISI 4140 | 0.47 | 0.90 | 0.26 | 0.11 | 0.001 | 0.11 | 1.06 | 0.2 | 0.13 | 0.003 |

| Ex | ID | Nb | Ti | Al | N | B | Sn | Sb | As | Ca | O | H |
|---|---|---|---|---|---|---|---|---|---|---|---|---|
| INV | A | 0.003 | 0.012 | 0.031 | 0.0055 | 0.0002 | 0.013 | 0.001 | 0.005 | 0.0021 | 0.0001 | 0.00029 |
| INV | B | 0.003 | 0.011 | 0.033 | 0.0064 | 0.0003 | 0.012 | 0.003 | 0.006 | 0.0011 | 0.0002 | 0.00018 |
| INV | C | 0.003 | 0.012 | 0.031 | 0.0054 | 0.0002 | 0.013 | 0.002 | 0.005 | 0.0014 | 0.0001 | 0.00016 |
| INV | D | 0.003 | 0.012 | 0.033 | 0.0051 | 0.0003 | 0.011 | 0.003 | 0.005 | 0.0014 | 0.0001 | 0.00018 |
| INV | E | 0.003 | 0.011 | 0.032 | 0.0045 | 0.0002 | 0.011 | 0.002 | 0.005 | 0.002 | 0.0001 | 0.00019 |
| COMP | F | | | | | | | | | | | |
| COMP | G | | | | | | | | | | | |
| COMP | H | | | 0.03 | | | | | | | 0.002 | |
| COMP | I | | | | | | | | | | | |
| COMP | J | | | | | | | | | | | |
| COMP | K | | | | | | | | | | | |
| COMP | L | | | | | | | | | | | |
| COMP | M | 0.001 | 0.002 | 0.02 | | | | | | | | |
| COMP | N | 0.026 | 0.038 | 0.017 | | | | | | | | |
| COMP | O | 0.054 | 0.027 | 0.015 | | | | | | | | |
| COMP | P | | | 0.035 | | | | | | | | |
| COMP | Q | | | | | | | | | | | |
| COMP | R | | | | | | | | | | | |
| COMP | S | | | | | | | | | | | |
| COMP | T | | | | | | | | | | | |
| COMP | V1 | | | | | | | | | | | |
| COMP | V2 | | | | | | | | | | | |
| COMP | V3 | | | | | | | | | | | |
| COMP | W1 | | | | | | | | | | | |
| COMP | W2 | | | | | | | | | | | |
| COMP | Z1 | 0.002 | 0.003 | 0.028 | 0.005 | 0.0002 | 0.011 | | | | | |
| COMP | Z2 | 0 | 0.003 | 0.032 | 0.005 | 0.0002 | 0.011 | | | | | |

Table 2. Source comparative examples

TABLE 3
Heat treatment

| | | | Quenching | | | |
|---|---|---|---|---|---|---|
| | Austenitizing | | | Min. cooling rate | Tempering | |
| | Temperature | Holding | | (° C./s between | Temperature | Holding |
| ID | (° C.) | (min) | Cooling | 800° C. and 500° C.) | (° C.) | (min) |
| A/1 | 880 | 150 | Water and polymer, tank | 5.8 | 650 | 210 |
| A/2 | 880 | 150 | Water and polymer, tank | 4.4 | 650 | 210 |
| A/3 | 880 | 150 | Water and polymer, tank | 6.0 | 650 | 210 |
| C | 880 | 120 | Water and polymer, tank | 6.0 | 650 | 210 |
| D | | | | 3.5 | | |
| E | 920 | 38 | Water, ring spray | 6.0 | i) 660 | i) 61 |
| | | | | | ii) .675 | ii) 61 |
| F | 850 | — | Air | | 650 | — |
| G | 840 | — | Steam | | 650 | — |
| H | 850 | 30 | Oil | | 670 | 120 |
| I | 870 | | Oil | | 620 | |
| J | 860 | | | | 630 | |
| K | 860 | | | | 460 | |
| L | 860 | | | | 630 | |
| Q | | | Liquid | | 660 | |

TABLE 4
Dimensions Examples

| | Outer diameter | Wall thickness | Length (total) |
|---|---|---|---|
| ID | (mm) | (mm) | (mm) |
| A/1 | 457 | 40 | — |
| A/2 | 406.4 | 47.5 | — |
| A/3 | 470 | 38.8 | 7500 |
| B | | | |
| C | 470 | 38.8 | — |
| D | 360 | 54.5 | — |
| E | 470 | 38.8 | — |
| F | | | |
| G | | | |
| H | | | |
| I | Plate | 40 | |
| J | 318.5 | 70 | |
| K | | | |
| L | 355.6 | 25.2 | |
| M | 914 | 10.6 | |
| N | 508 | 10.6 | |
| O | 914 | 18-22 | |
| P | 630 | 17 | |
| Q | | | |
| R | | | |
| S | | | |
| T | | | |
| V1 | | | |
| V2 | | | |
| V3 | | | |
| W1 | | | |
| W2 | | | |

TABLE 5
Non-metallic inclusions

| | A (sulfide) | | B (alumina) | | C (silicates) | | D (globular oxide) | | |
|---|---|---|---|---|---|---|---|---|---|
| ID | Thin | Heavy | Thin | Heavy | Thin | Heavy | Thin | Heavy | Oversize |
| A | 0 | 0 | 0.5 | 0 | 0 | 0 | 1.5 | 0.5 | None |
| A | 0 | 0 | 0.5 | 0 | 0 | 0 | 1.5 | 0.5 | None |
| A | 0 | 0 | 0.5 | 0 | 0 | 0 | 1 | 0.5 | None |
| B | 0 | 0 | 1 | 0 | 0 | 0 | 1.5 | 0.5 | None |

TABLE 6
Grain size

| | Grain size | Grain size |
|---|---|---|
| ID | (ASTM) | (m.l.i., μm) |
| A/3 | 7-8 | 20-30 |
| H | 8 | 20 |

TABLE 7
Parameters

| | | Quench | Precipitation |
|---|---|---|---|
| ID | Hardenability | cracking | hardening |
| A | 3.8 | 2.38 | 107 |
| B | 3.8 | 2.35 | 108 |
| C | 3.8 | 2.41 | 107 |
| D | 3.8 | 2.37 | 108 |
| E | 3.7 | 2.31 | 104 |
| F | 3.4 | 1.83 | 132 |
| G | 4.2 | 2.36 | 136 |
| H | 3.0 | 1.90 | 109 |
| I | 4.2 | 3.10 | 131 |
| J | 4.3 | 3.28 | 132 |
| K | 3.0 | 1.90 | 118 |
| L | 3.3 | 2.08 | 117 |
| M | 1.9 | 1.07 | 65 |
| N | 1.4 | 0.61 | 21 |
| O | 1.8 | 0.80 | 15 |
| P | 2.5 | 1.42 | 92 |
| Q (min) | 2.8 | 1.71 | 105 |
| Q (max) | 4.0 | 3.13 | 153 |
| R | 2.3 | 1.07 | 35 |
| S | 3.7 | 2.83 | 145 |
| T | 4.1 | 2.94 | 125 |
| V1 | 2.5 | 1.42 | 92 |
| V2 | 3.7 | 2.83 | 145 |
| V3 | 3.4 | 2.46 | 134 |
| W1 | #N/B | #N/B | #N/B |
| W2 | #N/B | #N/B | #N/B |
| Z1 | 3.1 | 1.93 | 116 |
| Z2 | 3.7 | 2.75 | 142 |

TABLE 8
Tensile properties

| | Tensile properties | | | |
|---|---|---|---|---|
| | Yield strength | Tensile strength | | |
| ID | (MPa) | (MPa) | Y/T | Elongation (%) |
| A/1 | 690-726 | 820-875 | 0.82-0.84 | 18-20 |
| | (avg. 710) | (avg. 853) | (avg. 0.83) | (avg. 19) |
| A/2 | 719-777 | 825-920 | 0.83-0.89 | 20.5-23.5 |
| | (avg. 750) | (avg. 886) | (avg. 0.85) | (avg. 22.2) |
| A/3 | 702-778 | 847-931 | 0.82-0.85 | 18.5-23.5 |
| | (avg. 747) | (avg. 892) | (avg. 0.84) | (avg. 21.6) |
| D | 690-713 | 852-870 | 0.81-0.83 | 22-23.5 |
| | (avg. 705) | (avg. 859) | (avg. 0.82) | (avg. 22.5) |
| E | 730-751 | 884-903 | 0.82-0.83 | 21.5-22.5 |
| | (avg. 737) | (avg. 891) | (avg. 0.83) | (avg. 22) |
| F | 575 | 718 | 0.8 | 20.5 |
| G | 602 | 726 | 0.83 | 28 |
| H | 689 | 797 | 0.86 | 20 |
| I | 808 | 957 | 0.84 | |
| J | 750-801 | 903-933 | 0.85 | 17-19 |
| K | 1232 | 1365 | 0.9 | |
| M | 325 | 526 | 0.62 | 15 |
| N | 488 | 588 | 0.83 | 20.9 |
| O | 509 | 609 | 0.84 | 29.7 |
| Q | 642-704 | 839-901 | 0.82 | 19.3-24 |

TABLE 9
Toughness

| | Air | | |
|---|---|---|---|
| | K_{IC} (MPa/m^{0.5}) | Hydrogen | K_{IH} (MPa/m^{0.5}) |
| ID | at RT | p (MPa) | at RT |
| A | 273 | 103 | 56 |
| P | | 45 | 52 |
| T | | 115 | 42 |
| V1 | | 103 | 53 |
| V2 | | 103 | 47 |
| V3 | | 103 | 26 |
| W | 116 | 115 | 41 |
| W | 116 | 35 | 36 |

TABLE 10
Hardness (as-quenched)

| | As-quenched hardness (HRC) at location | | | | | |
|---|---|---|---|---|---|---|
| | Cylinder body | | | Shoulder and nozzle | | |
| | Internal | | External | Internal | | External |
| ID | surface | Mid-wall | surface | surface | Mid-wall | surface |
| A/2 | 51-54* | 52-55* | 52-54* | — | — | — |
| A/3 | 51-53 | 52-54 | 52-54 | 52-54 | 53-55 | 52-54 |
| E | 52-53 | 50-52 | 51-55 | 49-54 | 48-53 | 47-55 |

TABLE 11
Hardness (Q&T)

| | Hardness |
|---|---|
| ID | HV10 min.-max. (avg.) |
| A/1 | 241-273 (253) |
| A/2 | 260-290 (279) |
| A/2 | 265-290 (278) |
| H | 261 |
| K | 437 |
| L | 256 |

TABLE 12
Impact (Charpy)

| | Charpy V-notched specimen impact (minimum/average; FATT) | | | | |
|---|---|---|---|---|---|
| | Absorbed energy (J) | Shear area (%) | Absorbed energy (J) | Shear area (%) | FATT |
| ID | at −50° C. | at −50° C. | at −40° C. | at −40° C. | (° C.) |
| A/1 | 148/172 | — | — | — | |
| A/2 | 130/150 | 85/90 | 143/156 | 85/95 | |
| | — | — | 116/148 | 85/90 | |
| C | — | — | 132/160 | 85/90 | |
| | — | — | 130-179 | 85/90 | |
| I | <51 J | <50 | <51 | >50 | −2 |

1. A steel composition, comprising, in wt. %:
C: 0.25-0.35;
Si: 0.20-0.35;
Mn: 0.40-0.60;
Cr: 1.20-1.70;
Ni: 1.40-1.90;
Mo: 0.15-0.25;
Al: 0.015-0.035;
Nb: 0.001-0.040;
V: 0.001-0.060;
N: 0.0030-0.0120;
Ca: 0.0010-0.0030; and
Fe.

2. The steel composition according to claim 1, the steel composition further comprising, in wt %:
W: 0-0.20; and
B: 0-0.0030, wherein
4 C+Mn+0.6 Cr+0.5 Ni+Mo+0.5 W+166 B≥3.7;
[C+(Mn+Mo+W/2)/5+(Cr+Ni+V)/10]/[539−423 C−30.4 Mn−17.7 Ni−12.1 Cr−7.5 (Mo+0.5 W)−11 Si]×1000≤2.8; or
270 C+70 (Mo+W/2)+450 V≥80.

3. The steel composition according to claim 1, wherein, in wt. %:
Cr: 1.40-1.70; and
Ni: 1.50-1.90.

4. The steel composition according to claim 1, wherein, in wt. %:
Cr: 1.20-1.50;
Ni: 1.40-1.70;
Ti: 0.010-0.025; and
B: 0.0015-0.0030.

5. The steel composition according to claim 1, wherein, in wt. %:
C: 0.25-0.33.

6. The steel composition according to claim 1, the steel composition further comprising, in wt. %:
W: 0-0.15.

7. The steel composition according to claim 1, the steel composition further comprising, in wt. %:
H: 0-0.00018.

8. The steel composition according to claim 2, wherein
4 C+Mn+0.6 Cr+0.5 Ni+Mo+0.5 W+166 B≥4.1.

9. The steel composition according to claim 2, wherein
[C+(Mn+Mo+W/2)/5+(Cr+Ni+V)/10]/[539−423 C−30.4 Mn−17.7 Ni−12.1 Cr−7.5 (Mo+0.5 W)−11 Si]×1000≤2.6.

10. The steel composition according to claim 2, wherein
270 C+70 (Mo+W/2)+450 V≥100.

11. The steel composition according to claim 1, wherein the steel composition comprises up to a maximum content of one or more non-metallic inclusions, the maximum content of the respective non-metallic inclusions comprising in wt. %:
sulphide:
Thin: 0;
Heavy: 0;
alumina:
Thin: 1.5;
Heavy: 1.0;
silicates:
Thin: 1.5;
Heavy: 1.0; and
globular oxide:
Thin: 2.0;
Heavy: 1.0.

12. A wrought steel article, having a steel composition according to claim 1 and a microstructure comprising 85% or more martensite by weight, a remainder comprising ferrite or bainite.

13. The wrought steel article according to claim 12, having at least one of the properties selected from the group consisting of:
Tensile strength (TS): ≥840 MPa;
Yield strength (YS): ≥660 MPa; and
Hardness: ≥240 HV;
and at least one of the properties selected from the group consisting of:
Total elongation: ≥15%;
Impact energy (V-notched sample): >100 J at −50° C. and >100 J at −40° C.;
Shear area: >50% ductile at −50° C.;
>80% ductile at −40° C.; and
Toughness: In air, K_{IC}>250 MPa m^{0.5} from RT down to −40° C.,
In hydrogen at 200-1000 bar, K_{IC}>50 MPa m^{0.5} at RT.

14. The wrought steel article according to claim 13, wherein the wrought steel article has
Ratio YS/TS: ≤0.90.

15. The wrought steel article according to claim 13, wherein the wrought steel article has
Tensile strength (TS): 840-1250 Mpa,
Yield strength (YS): 660-1100 Mpa, and
Hardness: 240-300 HV.

16. The wrought steel article according to claim 13, wherein the wrought steel article has
Fatigue resistance in hydrogen:
at 55 MPa H₂:
DA/DN<4·10-8 M/CYCLE AT R=0.1 AND ΔK≤10 MPA*M1/2;
DA/DN<2·10-8 M/CYCLE AT R=0.7 AND ΔK≤7 MPA*M1/2;
and at 106 MPa Hz:
DA/DN<6·10-8 M/CYCLE AT R=0.1 AND ΔK≤10 MPA*M1/2;
DA/DN<5·10-8 M/CYCLE AT R=0.7 AND ΔK≤7 MPA*M1/2.

17. A method of manufacturing a seamless pressure vessel, the method comprising:
providing a hot-rolled seamless semi-finished object having a tubular body having a steel composition comprising, in wt. %:
C: 0.25-0.35;
Si: 0.20-0.35;
Mn: 0.40-0.60;
Cr: 1.20-1.70;
Ni: 1.40-1.90;
Mo: 0.15-0.25;
Al: 0.015-0.035;
Nb: 0.001-0.040;
V: 0.001-0.060;
N: 0.0030-0.0120;
Ca: 0.0010-0.0030; and
Fe;
austenitizing the hot-rolled seamless semi-finished object having a tubular body between Ac3 and the grain coarsening temperature for a period of time sufficient to ensure full transformation;
quenching the object having a tubular body that has been subjected to austenitizing to a temperature below Mf at a cooling rate of at least 3° C./s between 800 and 500° C.; and
tempering the quenched seamless object having a tubular body at a temperature in the range of 600° C.—Ac1.

18. The method according to claim 17, wherein the austenitizing is performed in the range of 840-900° C. % if V≤0.03%; and in the range of 900-960° C. if V≥0.03% and/or Nb≥0.015.

19. The method according to claim 17, wherein the austenitizing includes holding the hot-rolled seamless semi-finished object having a tubular body at a furnace temperature within ±10° C. from the targeted temperature in the range between Ac3 and the grain coarsening temperature for a period of time having a minimum time defined by wall thickness*1 min/mm wall thickness and a maximum time of 240 min.

20. The method according to claim 17, wherein the tempering is performed at a temperature in the range of 600-700° C.

21. The method according to claim 17, wherein the tempering comprises holding the object having a tubular body that has been subjected to austenitizing for a period of time having a minimum value of at least wall thickness*3 min/mm wall thickness.

22. The method according to claim 17, wherein the providing the hot-rolled seamless semi-finished object having the tubular body comprises:
heating a round billet;
piercing the billet;
hot rolling the billet;
sizing the billet;
cooling to room temperature;
cutting the billet; and
end forging the billet.

23. The method according to claim 17, wherein the prior austenitic grain size number is 7 or finer.

24. A high pressure hydrogen gas storage cylinder formed from the wrought steel article according to claim 12.

25. A method, comprising:
providing a pressure vessel formed from a wrought steel article having a steel composition comprising, in wt. %:
C: 0.25-0.35;
Si: 0.20-0.35;
Mn: 0.40-0.60;
Cr: 1.20-1.70;
Ni: 1.40-1.90;
Mo: 0.15-0.25;
Al: 0.015-0.035;
Nb: 0.001-0.040;
V: 0.001-0.060;
N: 0.0030-0.0120;
Ca: 0.0010-0.0030; and
Fe
and a microstructure comprising 85% or more martensite by weight, a remainder comprising ferrite or bainite; and
storing compressed gas at a pressure up to 120 MPa in the pressure vessel.
